(19) United States
(12) Patent Application Publication
(10) Pub. No.: US 2016/0108245 A1
(43) Pub. Date: Apr. 21, 2016

(54) Corrosion-Resistant Metal-Effect Pigments, Method for Producing the Same and Use Thereof

(71) Applicant: Ulrich-Andreas HIRTH, Bayreuth (DE)

(72) Inventor: Ulrich-Andreas Hirth, Bayreuth (DE)

(21) Appl. No.: 14/894,133

(22) PCT Filed: Jun. 2, 2014
(86) PCT No.: PCT/EP2014/061402

§ 371 Date: Nov. 25, 2015

(30) Foreign Application Priority Data
May 31, 2013 (DE) 10 2013 009 692.8

(51) Int. Cl. C09C 1/00; C09D 5/03; C09D 5/38; C09D 7/12

(52) U.S. Cl. CPC C09C 1/0021; C09D 7/1225; C09D 5/035; C09D 5/38; C09C 2200/307; C09C 2200/1058; C09C 2200/405; C01P 2004/20; C01P 2004/54; C08K 9/04

(57) ABSTRACT

Metal-effect pigment including a metallic, plate-shaped core, which is coated with at least one polymer layer, wherein the polymer layer is homogeneous polyurea-type polymer, wherein the polyurea-type polymer of the polaner layer is obtained by an addition reaction of a component A with a component B, wherein component A includes molecules including 1-20 primary and/or secondary amino groups and component B includes molecules including 1-20 isocyanate groups.

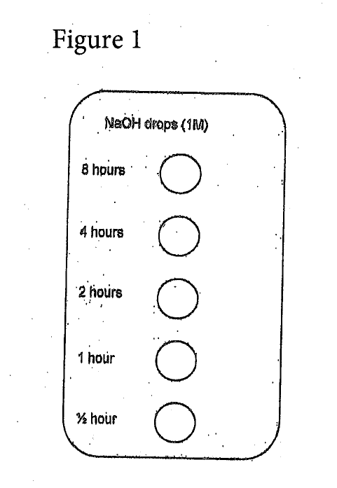

The present invention relates to metal-effect pigments which are resistant to chemicals and corrosive influences and have a polymeric organic protective layer.

The optical effect of metal-effect pigments is based on the regular reflection of light at plate-shaped pigment particles which are ideally aligned plane-parallel. The brightness and in some cases also the color shade changes with the observation angle. Their metallic gloss and their excellent covering capacity are characteristic of metal-effect pigments. Of importance for the optical impression are an optimal distribution, a plane-parallel orientation in the coating film and a sufficient resistance to corrosion of the metal-effect pigments in the processing, coating and application medium.

Thus, metal-effect pigments are stable in aqueous media to only a very limited extent. For example, aluminum pigments decompose in water relatively quickly, forming hydrogen and aluminum hydroxide. In order to prevent this, the metal pigment surfaces are often protected by phosphatization, chromating or silanization. In addition, metal-effect pigments which are coated with a polymeric organic protective layer are also increasingly gaining in importance.

EP 0 477 433 B1 describes metal pigments based on aluminum which are coated with synthetic resin, wherein a synthetic resin layer is covalently bonded over a siloxane coating which is applied to the effect-pigment surface. The siloxane layer, as adhesion promoter, is to ensure a good bond of the synthetic resin coating to the effect-pigment surface. However, it has been shown that the action of shear forces can lead to a partial detachment of the synthetic resin layer. Therefore, these pigments are not reliably gassing-stable or resistant to corrosion.

EP 0 280 749 B1 discloses resin-coated metal pigments wherein an ethylenically unsaturated carboxylic acid and/or a phosphoric acid mono- or diester is arranged, as adhesion promoter, between pigment surface and synthetic resin layer. The carboxyl group of the carboxylic acid monomer or the phosphoric acid groups of the phosphate monomer bind to the metal pigment surface. Further monomers are reacted with the ethylenic double bonds thus arranged on the metal pigment surface to form a strongly crosslinked synthetic resin layer. Despite this three-dimensional structure of the synthetic resin coating, the gassing stability of these metal pigments in aqueous media is comparatively low.

Chemically resistant metal-effect pigments which are coated with oligomeric and/or polymeric binding agents which can be thermally crosslinked and/or crosslinked under UV or IR radiation are known from WO2005/063897. In this way, the metal-effect pigments can be embedded in a polymeric varnish film. After the coating of the metal-effect pigments, the binding agents can still be thermally cured and polymerized, which is why these metal-effect pigments are used in powder coatings. Although the pigments can be easily prepolymerized during the coating of the metal-effect pigments or during the removal of the solvents, they do not cure. A precoating of the pigment surface with functionalized silanes, polymers or organophosphorus compounds improves the adhesion of the pigment coating.

Metal-effect pigments, the surface of which has been modified with orientation aids, are known from EP 1 084 198 B1. The orientation aid present in monomeric or polymeric form carries at least two different functional groups which are separated from each other by a spacer. One of the functional groups is chemically bonded to the metal-effect pigment, the other can be linked to the binding agent of the surrounding varnish in a crosslinking reaction and thus make an additional contribution to the stabilization of the metal-effect pigment. In this way, metal-effect pigments are to be obtained which are to be readily wettable, orientate themselves excellently in the liquid varnish film and, after the film has dried, are to form a strong bond with the surrounding binding agent matrix. The resistance of a cured varnish to condensation water is thereby to be significantly improved.

U.S. Pat. No. 4,213,886 discloses a coated aluminum pigment, wherein in a first layer a silane with a monoethylene group and subsequently an acrylate resin layer are applied. It has been shown that this two-layered structure made of a silane layer and a subsequent acrylate resin layer is not sufficiently impermeable to the ingress of water and chemicals.

In DE 10 2005 037 611 A1, metal-effect pigments with an inorganic/organic mixed layer are described which, in addition to a high mechanical stability, are also to have a good stability to gassing in water varnishes. In the mixed layer, organic oligomers and/or polymers are to be at least partially covalently bonded to an inorganic network consisting of inorganic oxide components via network formers such as for example organofunctional silanes.

In DE 10 2004 006 145 A1, plate-shaped substrates with a functional multilayer structure consisting of one or more layers of a polymer and one or more layers of a silane are described. The layers made of one or more silanes are to perform a barrier function, while the layers made of one or more polymers are to stabilize the pigments mechanically and against a tendency to agglomerate.

In DE 10 2007 006 820 A1, metal-effect pigments are described which consist of a uniform synthetic resin coating and are constructed from polyacrylate-functional, polymethacrylate-functional and organofunctional silane units. The metal-effect pigments treated in this way are attributed non-conductive electrical properties and a relatively good resistance to chemicals and corrosion.

U.S. Pat. No. 4,434,009 describes a polymer coating of metal pigments which is constructed from monomers which have a polymerizable double bond and an epoxy group.

Another polymer coating of metal pigments is described in JP 56-161470. Here, the coating is carried out by means of monomers of the styrene, (meth)acrylonitrile or (meth)acrylic acid type.

Similar polymer-coated metal pigments are described in the unexamined patent application DE 25 26 093.

DE 102 09 359 A1 discloses plate-shaped effect pigments coated with cured melamine-formaldehyde resin.

WO 2004/029160 describes effect pigments, encased in LCST and/or UCST polymers, which are to be stable in aqueous solution in a pH range of from 3 to 9.

U.S. Pat. No. 6,191,248 B1 discloses a coating formulation in which metal pigments are mixed with alicyclic isocyanates and alicyclic polyurea ketimines. However, this is not a coating of individual metal flakes, but already a finished coating formulation.

Common to the described polymer coatings is that the polymer network was totally or partially generated by radical polymerization. Here, radical initiators are used, the decomposition products of which are poisonous and extremely hazardous to health. Thus, for example, the radical initiator AIBN (azo-bis-(isobutyrodinitrile)), which is very frequently used in the radical polymerization for encasing the metal pigments, forms the toxic decomposition product tetramethylsuccinic acid dinitrile, which is found again in not insignificant quantities on the corresponding polymer-coated metal-effect pigments. This is also one of the important reasons why these metal-effect pigments which are polymer-coated with the aid of AIBN are not used in packaging materials for direct contact with foodstuffs. The use of polymer-coated metal-effect pigments in which AIBN is used in the radical polymerization process is therefore restricted to applications in which a danger to the health of users and consumers can be ruled out.

In addition, radical polymerizations proceed in a rather uncontrolled manner and therefore do not lead to a homogeneous, continuously closed polymer encasing of the metal-effect pigment.

A further disadvantage of the radical polymerization of (meth)acrylates is that these monomers only have a low affinity for metal-pigment surfaces. The polymerization is thereby initiated in solution instead of on the metal-effect pigment surface, which leads to secondary precipitations and a very granular polymer layer. Some documents disclose the use of adhesion promoters between metal-pigment surface and polymer layer. Here too, however, the adhesion promoters must first bind securely to the metal-pigment surface. This is often not successful or at least not in the medium in which the polymerization is carried out, which leads to a complicated production process.

In addition, the polymer encasings with adhesion promoters sometimes prove not to be resistant to increased mechanical forces, such as for example act on the coated metal-effect pigments in a bonding process in the powder coating.

The object of the present invention is to provide metal-effect pigments which are resistant to corrosive chemicals and media. The metal-effect pigments are to have a good compatibility with the application medium, in particular with powder coatings.

The object is achieved according to the invention by the provision of metal-effect pigments with a plate-shaped, metallic core and a homogeneous, polyurea-type polymer layer encasing the plate-shaped metal core, wherein the polymer layer is obtained by an addition reaction of a component A with a component B, wherein component A has molecules which contain 1-20 primary and/or secondary amino groups and component B has molecules which contain 1-20 isocyanate groups.

Within the scope of this invention, by an encasing homogeneous polyurea-type polymer layer is meant that the polymer layer coats the individual metal-effect pigment particles. The coating is applied in a separate step, before the metal-effect pigments coated in this way are incorporated into a formulation such as e.g. a varnish or a printing ink, With this, the coating of the encasing homogeneous polyurea-type layer thus does not take place in the finished varnish. Thus, the metal-effect pigments are not coated during the application of the coating composition.

The polymer layer encasing the metallic core is characterized in that it is constructed from two components of different types, component A and component B, by means of an addition reaction. Component A has molecules which contain 1-20, preferably 2-15 primary and/or secondary amino groups. Component B has molecules which contain 1-20, preferably 2-15 isocyanate groups.

According to a preferred embodiment, component A has 1-20, preferably 2-15, further preferably 3-10, primary and/or secondary amino groups.

According to a preferred embodiment, component B has 1-20, preferably 2-15, further preferably 3-10, isocyanate groups.

The polyurea-type polymer layer develops by means of the formation of a polymer network which encases the metallic effect pigment core, by addition of the NH function of component A to the NCO functions of component B. This reaction already proceeds very rapidly, weakly exothermically and largely without side reactions at room temperature in anhydrous organic solvents.

It has surprisingly been shown that a polyurea-type polymer layer on which the invention is based adheres extremely firmly and reliably to the metal-pigment surface and is also extraordinarily stable vis-a-vis mechanical shear forces. Moreover, it has been shown that the polyurea-type polymer layer protects the delicate metal core against aggressive and corrosive chemicals and media over a long period, with the result that their optical properties such as gloss and color are not impaired.

A further advantage of the present invention is that the coating reaction takes place at room temperature. Previous methods of the state of the art always take place at temperatures around 80° C. or above. Carrying out the coating reaction at room temperature saves time and energy.

The metal-effect pigments according to the invention are further characterized in that the homogeneous, urea-type polymer layer can be relatively thin, whereby, on the one hand, the production costs can be reduced because of the low material usage and, on the other hand, an influencing of the gloss and color of the metal-effect pigments by means of the applied encasing polyurea-type polymer layer is largely eliminated.

The thickness of the homogeneous, urea-type polymer layer is preferably selected from a range of from 5 to 1000 nm, particularly preferably from a range of from 10 to 150 nm and quite particularly preferably from a range of from 30 to 70 nm.

The weight of the polyurea-type polymer layer is preferably in a range of from 0.5 to 80 wt.-%, relative to the total weight of the metal-effect pigment according to the invention. The weight of the polyurea-type polymer layer is particularly preferably in a range of from 5 to 70 wt.-%, and quite particularly preferably in a range of from 15 to 60 wt.-%, in each case relative to the total weight of the metal-effect pigment according to the invention. In individual cases, the quantity by weight to be chosen will depend on the fineness and thickness of the metallic, plate-shaped core.

Below the lower weight range data named above, the polymer coating no longer has a sufficiently corrosion-proof effect. Above the upper weight range data named above, the covering power, and consequently the surface area covered per weight unit of pigment, of the metal-effect pigments according to the invention falls too steeply and the corrosion-protection properties no longer improve significantly.

Furthermore, it is advantageous that the polyurea-type polymer layer can be applied in a one-step method, which has an extremely cost-efficient effect on the production costs.

In addition to components A and components B, the polyurea-type polymer layer can also contain further other chemical components. The proportion of the polyurea-type polymer layer is preferably at least 50 wt.-% of the weight of the coating of the metal-effect pigments. These other chemical components can be additives, such as corrosion inhibitors, colored pigments, dyes, UV stabilizers etc. or mixtures thereof.

The polyurea-type polymer layer preferably contains 70 to 100 wt.-% polyurea, relative to the total weight of the encasing polymer layer. The encasing polymer layer further preferably contains 80-100 wt.-% polyurea and quite particularly preferably 90 to 100 wt.-% polyurea, in each case relative to the total weight of the encasing polymer layer.

The molar ratio of the isocyanate groups of component B to the amino groups of component A is preferably in a range of from 0.9 to 1.1; particularly preferably in a range of from 0.95 to 1.07 and quite particularly preferably in a range of from 1.00 to 1.05. As a rule, the isocyanate groups react substantially completely, preferably completely, with the amino groups to form a urea group. However, it can be advantageous for the polyurea layer to have a slight excess of isocyanate groups in order to use these functionalities for bonding surface-modifying agents. Such surface-modifying agents are preferably amino silicones or fatty amines. After the formation of an encasing polyurea layer on the metal-effect pigments, such compounds will react with excess isocyanate groups of the polyurea coating because of their amino groups and are thus bonded to the surface of the coated metal-effect pigment. Because of their hydrophobic residue, they give the metal-effect pigments modified in this way a particularly high stability vis-à-vis agglomeration and lead to an improved pigment orientation in the application medium. This is expressed in an increased covering capacity and a stronger light-dark flop, compared with metal pigments according to the invention which do not have such a surface modification.

In other embodiments, it is advantageous to have a certain excess of amino groups in the polymer coating because excess amino groups can both bond to the metal-effect pigment surface, in order to enable a good adhesion to the surface of the metal-effect pigment, and be available on the surface of the polymer layer as functional groups for the surface modification. Embodiments with a molar ratio of the isocyanate groups of component B to the amino groups of component A in a range of from 0.9 to 0.99 are also therefore preferred and those in a range of from 0.95 to 0.98 are further preferred.

The components on which components A are based preferably comprise primary and/or secondary mono-, di- or polyamines and/or polyamidoamines with 1-20 amino groups. The components on which components A are based particularly preferably have 2 to 4 amino groups.

Monoamines are only used in very small quantities because they substantially enable a termination of an addition polymerization but do not enable any further polymerization. Monoamines are therefore preferably only used in quantities of from 0 to 15 wt.-%, relative to the total weight of component A.

In particularly preferred embodiments, components A only have 10 mol.-%, further preferably only 5 mol.-% and quite particularly preferably 0 mol.-% hydroxyl groups, compared with the number of amino groups. It has been shown that the presence of hydroxyl groups, which react with isocyanate groups to form a urethane group, is not beneficial for the stability of the polymer layer.

Furthermore, preferred embodiments have no toxic constituents in the coating of the metal-effect pigments according to the invention.

Examples of suitable monoamines are stearyl amine, palmitoleic amine, caprylic amine, cyclohexylamine or butylamine.

Examples of suitable diamines are isophorone diamine, 2,2,4-trimethylhexane diiamine, 2,4-toluylenediam, ethylene diamine, propylene diamine, hexamethylene diamine or tetramethylene diamine.

Examples of suitable higher functional amines or polyamines and/or polyamidoamines are PAMAM CeTePox 1950 H, triethylene tetramine, N,N′-bis-(3-aminopropyl)ethylene diamine, N,N-dimethyldipropylene triamine, diethylene triamine or polyethylenimine (e.g. obtainable under the name Luprasol® (BASF)).

In a particularly preferred embodiment, component A has a mixture of an isophorone diamine and an aliphatic diamine. The weight ratio of isophorone diamine to aliphatic diamine is preferably 3:1 to 1:2 and further preferably 2:1 to 1:1.

The components on which components B are based preferably comprise mono-, di- and/or polyisocyanates and/or isocyanate-containing prepolymers with 1-20 isocyanate groups. The components on which components B are based preferably have 2 to 6 isocyanate groups (per monomer molecule).

Analogously to monoamines in the case of component A, monoisocyanates are only used in very small quantities as component B because they substantially enable a termination of an addition polymerization but do not enable any further polymerization. Monoisocyanates are therefore preferably only used in quantities of from 0 to 15 wt.-%, relative to the total quantity of component B.

Examples of suitable monoisocyanates are stearyl isocyanate, palmitoleic isocyanate, caprylic isocyanate, cyclohexyl isocyanate or butyl isocyanate.

Examples of suitable diisocyanates are isophorone diisocyanate, 2,2,4-trimethylhexane diisocyanate, 2,4-toluylene diisocyanate, hexamethylene diisocyanate or tetramethylene diisocyanate. Of course, the trimeric forms of such compounds can also be used.

Examples of suitable diisocyanates, polyisocyanates and/or isocyanate-containing prepolymers are Desmodur Z 4470 BA, Desmodur XP 2489, Desmodur N 75, Desmodur XP 2406 or Desmodur E 305 (all commercially available from Bayer Material Science).

In particularly preferred embodiments, both component A and component B have isophorone groups. It has completely surprisingly proved that the polymerization proceeds excellently with such groups and particularly corrosion-proof encasings of the metal-effect pigments are obtained. Extremely preferably, component A has isophorone-containing diamines and component B has isophorone-containing diisocyanates.

It is presumed that the isophorone-containing diamines or diisocyanates have a particularly high affinity for the surfaces of the metal-effect pigments. They are therefore adsorbed at least partially on the surface of the metal-effect pigments before the start of the addition polymerization and the polymerization thereby preferably takes place on the surface of the metal-effect pigments. This results in an impermeable polymer layer which encases the metallic, plate-shaped cores evenly and has a very low proportion of secondary precipitations.

The plate-shaped metallic cores are preferably selected from at least one metal, which has or consists of aluminum, copper, tin, zinc, iron, chromium, nickel, silver gold, gold bronze, brass or steel or mixtures or alloys thereof. The plate-shaped metallic core preferably has or consists of aluminum, copper, iron or gold bronze. The plate-shaped metallic core particularly preferably has or consists of aluminum.

The proportion of aluminum is further preferably in a range of from 90 to 100 wt.-%, further preferably from 98 to 99.99 wt.-%, in each case relative to the total weight of the aluminum pigment.

The plate-shaped metal pigments preferably have an average diameter of 1-200 μm, further preferably of 3-140 μm, still further preferably of 5-95 μm. The average thickness of the plate-shaped metal pigments is preferably in a range of from 20 nm to 1 μm, further preferably from 30 nm to 750 nm, still further preferably from 40 nm to 600 nm.

The shape factor, i.e. the ratio of average diameter (D₅₀) to average thickness (h₅₀), is preferably in a range of from 1000:1 to 5:1, further preferably from 500:1 to 10:1, still further preferably from 300:1 to 100:1.

The plate-shaped metal pigments can be metal pigments obtained by grinding, preferably aluminum pigments, or pigments obtained by physical vapor deposition (PVD), preferably PVD pigments.

The use of the metal-effect pigments according to the invention in paints, printing inks, varnishes, powder coatings, plastics and cosmetics is also a subject of the invention. The metal-effect pigments according to the invention are preferably used in powder coatings. Powder coating applications for interior use are quite particularly preferred.

A coating system containing the metal-effect pigments according to the invention is also a subject of the invention. Here, the coating system can preferably consist of at least one material selected from the group paints, printing inks, varnishes, powder coatings, plastics and/or cosmetics.

A coated article which contains metal-effect pigments according to the invention or which contains a coating system containing at least one metal-effect pigment according to the invention is also a subject of the invention.

### EXAMPLES

The metal-effect pigments according to the invention are characterized by an extraordinary resistance to aggressive and corrosive substances and media, which is illustrated with reference to the following examples. The examples only serve to illustrate the invention further and do not limit the scope of the invention.

### Example 1

### According to the Invention:

100 g Alpate 7670 NS (Toyal Europe, Accous, France) was suspended in butyl acetate such that a 20 wt.-% suspension formed. The suspension was dispersed for 1 hour at room temperature. At the same time, two solutions of 9.98 g Desmodur Z 4470 BA in 20 g butyl acetate and 1.68 g diethylene triamine in 20 g butyl acetate were added to this dropwise over 1 hour at room temperature accompanied by constant stirring. Stirring was continued at room temperature for a further 4 hours after the addition had ended. The product was then filtered off, washed with white spirit and dried at 70° C. in a vacuum. The resulting weight was 76.47 g (=100% yield).

### Example 2

### According to the Invention:

100 g Alpate 8160 N AR (Toyal Europe, Accous, France) was suspended in butyl acetate such that a 20 wt.-% suspension formed. The suspension was dispersed for 1 hour at room temperature. At the same time, two solutions of 9.70 g Desmodur XP 2489 in 20 g butyl acetate and 1.96 g triethylene tetramine in 20 g butyl acetate were added to this dropwise over 1 hour at room temperature accompanied by constant stirring. Stirring was continued at room temperature for a further 4 hours after the addition had ended. The product was then filtered off, washed with white spirit and dried at 70° C. in a vacuum. The resulting weight was 76.48 g (=100% yield).

### Example 3

### According to the Invention:

100 g Alpate 1165 (Toyal Europe, Accous, France) was suspended in butyl acetate such that a 20 wt.-% suspension formed. The suspension was dispersed for 1 hour at room temperature. At the same time, two solutions of 10.58 g Desmodur N 75 BA in 20 g butyl acetate and 3.88 g isophorone diamine in 20 g butyl acetate were added to this dropwise over 1 hour at room temperature accompanied by constant stirring. Stirring was continued at room temperature for a further 4 hours after the addition had ended. The product was then filtered off, washed with white spirit and dried at 70° C. in a vacuum. The resulting weight was 76.47 g (=100% yield).

### Example 4

### According to the Invention:

100 g Alpate 8130 N AR (Toyal Europe, Accous, France) was suspended in butyl acetate such that a 20 wt.-% suspension formed. The suspension was dispersed for 1 hour at room temperature. At the same time, two solutions of 12.86 g Desmodur XP 2406 in 20 g butyl acetate and 1.29 g CeTePox 1490 H in 20 g butyl acetate were added to this dropwise over 1 hour at room temperature accompanied by constant stirring. Stirring was continued at room temperature for a further 4 hours after the addition had ended. The product was then filtered off, washed with white spirit and dried at 70° C. in a vacuum. The resulting weight was 76.36 g (=99% yield).

### Example 5

### According to the Invention:

100 g Alpate MG 1100 (Toyal Europe, Accous, France) was suspended in butyl acetate such that a 20 wt.-% suspension formed. The suspension was dispersed for 1 hour at room temperature. At the same time, two solutions of 8.09 g Desmodur E 305 in 20 g butyl acetate and 3.70 g CeTePox 1587 H in 20 g butyl acetate were added to this dropwise over 1 hour at room temperature accompanied by constant stirring. Stirring was continued at room temperature for a further 4 hours after the addition had ended. The product was then filtered off, washed with white spirit and dried at 70° C. in a vacuum. The resulting weight was 76.46 g (=100% yield).

### Example 6

### According to the Invention:

100 g Alpate MG 1100 (Toyal Europe, Accous, France) was suspended in butyl acetate such that a 20 wt.-% suspension formed. The suspension was dispersed for 1 hour at room temperature. At the same time, two solutions of 8.09 g Desmodur Z 4470 BA in 20 g butyl acetate and 3.70 g Vestamin IPD (Evonik) in 20 g butyl acetate were added to this dropwise over 1 hour at room temperature accompanied by constant stirring. Stirring was continued at room temperature for a further 4 hours after the addition had ended. The product was then filtered off, washed with white spirit and dried at 70° C. in a vacuum. The resulting weight was 76.46 g (=100% yield).

### Example 7

### According to the Invention:

100 g Alpate MG 1100 (Toyal Europe, Accous, France) was suspended in butyl acetate such that a 20 wt.-% suspension formed. The suspension was dispersed for 1 hour at room temperature. At the same time, two solutions of 8.09 g Desmodur Z 4470 BA in 20 g butyl acetate and 3.70 g of a mixture of Vestamin IPD (Evonik) and hexamethylene diamine in each case in the same proportions by weight (1:1) in 20 g butyl acetate were added to this dropwise over 1 hour at room temperature accompanied by constant stirring. Stirring was continued at room temperature for a further 4 hours after the addition had ended. The product was then filtered off, washed with white spirit and dried at 70° C. in a vacuum. The resulting weight was 76.46 g (=100% yield).

### Example 8

### According to the Invention:

The coating was carried out analogously to Example 7, wherein, however, 8.66 g Desmodur Z 4470 BA in 20 g butyl acetate was used as component B. 4 h after the addition of the amine components, 0.1 g Rofamin KD (Ecogreen Oleochemicals DHW Deutsche Hydrierwerke) was added to the reaction mixture for the surface modification and stirring was continued at room temperature for a further 2 hours.

### Example 9

### According to the Invention:

The coating was carried out analogously to Example 7, wherein, however, 8.66 g Desmodur Z 4470 BA in 20 g butyl acetate was used as component B. 4 h after the addition of the amine components, 0.1 g amino silicone Wacker L656 (non-reactive, aminofunctional polydimethylsiloxane, Wacker Chemie, Germany) was added to the reaction mixture for the surface modification and stirring was continued at room temperature for a further 2 hours.

Corrosion Stability Tests:

The effect pigments produced in accordance with Examples 1 to 9 according to the invention, as well as the pigments used as comparison pigments, were incorporated into a 1-component polyurethane varnish system with a pigment concentration of 10 wt.-%, relative to the total weight of the varnish.

These 1-component polyurethane varnish systems provided with the metal pigments according to the invention or with metal-effect pigments used for comparison purposes were each applied pneumatically to PMMA plates with a dry film thickness of 30 μm using a wet-coat gun and then dried for 2 hours at 80° C. in a circulating air drying oven.

24 hours after the curing of the applied varnish systems, 1 M caustic soda was applied in drops to each of the PMMA plates, wherein the drop sizes have a diameter of 12-15 mm. After the application of the drops at room temperature (22° C.), the caustic soda drops were allowed to act on the varnished surfaces of the PMMA plates for 1/2 hour, 1 hour, 2 hours, 4 hours and 8 hours. The drops were then rinsed off under running water and the PMMA plates were dried in air at room temperature (22° C.) for 4 hours. The areas of the drops on the varnished PMMA plates were then assessed visually according to the degree of graying.

Representation 1 Varnished PMMA plate with 1M caustic soda applied in drops

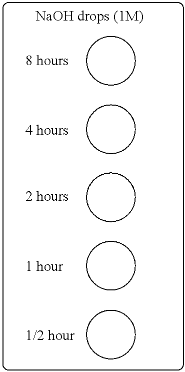

At each point in time, the degree of graying was evaluated according to the following assessment system:

0 points: no graying recognizable (no damage to the aluminum pigments)

1 point: slight, just recognizable appearance of graying (slight damage to the aluminum pigments)

2 points: clearly perceptible appearance of graying (clear damage to the aluminum pigments)

3 points: complete graying (total destruction of the aluminum pigments)

The points determined in each case over the abovenamed five periods (1/2 hour, 1 hour, 2 hours, 4 hours, 8 hours) were totaled.

The totaled values are reproduced in the following Table 1 for all of the pigments tested.

TABLE 1
Corrosion-resistance test in the 1-component
polyurethane varnish system

| | Average | Total | |
|---|---|---|---|
| | particle size | of the | Corrosion |
| Metal-effect pigment | D50 (μm) | evaluation | resistance |
| Comparison example 1: | 28 | 13 | poor |
| Asahi CR 21 (commercially | | | |
| available polyacrylate-coated | | | |
| aluminum pigment) | | | |
| Comparison example 2: | 22 | 14 | poor |
| Eckart NCP 501 (commercially | | | |
| available polyacrylate-coated | | | |
| aluminum pigment) | | | |
| Comparison example 3: | 16 | 8 | moderate |
| Eckart PCU 1500 (commercially | | | |
| available SiO2/polyacrylate- | | | |
| coated aluminum pigment) | | | |
| Comparison example 4: | 15 | 14 | poor |
| Showa 260 EA (commercially | | | |
| available polymer-coated | | | |
| aluminum pigment) | | | |
| Comparison example 5: | 21 | 13 | poor |
| Silberline (commercially available | | | |
| polymer-coated aluminum | | | |
| pigment) SBC 303-20Z | | | |
| Comparison example 6: | 17 | 14 | poor |
| Toyal 616EB (commercially | | | |
| available polyacrylate-coated | | | |
| aluminum pigment) | | | |
| Example 1 according to the | 15 | 2 | good |
| invention | | | |
| Example 2 according to the | 16 | 3 | good |
| invention | | | |
| Example 3 according to the | 20 | 1 | very good |
| invention | | | |
| Example 4 according to the | 21 | 1 | very good |
| invention | | | |
| Example 5 according to the | 36 | 0 | very good |
| invention | | | |
| Example 6 according to the | 35 | 0 | very good |
| invention | | | |
| Example 7 according to the | 36 | 0 | very good |
| invention | | | |
| Example 8 according to the | 36 | 0 | very good |
| invention | | | |
| Example 9 according to the | 36 | 0 | very good |
| invention | | | |

Furthermore, the metal-effect pigments according to the invention have a very good weather resistance and a very good dispersion behavior. Because of their excellent resistance to aggressive and corrosive substances and media and, not least, also because of their extraordinarily good resistance to shear forces, the metal-effect pigments according to the invention are very suitable for a wide variety of fields of application and varnish or paint and coating systems.

Moreover, the application examples of the pigments of Examples 8 and 9 according to the invention had the best covering power and the strongest light-dark flop of all of the samples.

Powder coating applications:

The metal-effect pigments according to the invention of Examples 1 to 9 as well as comparison example 7 (PCU 2000, Eckart GmbH) were weighed into a ThermoMix 2

(Vorwerck) at a pigmentation level of 2.0 wt.-% with the powder coating 89/00060 (epoxy/polyester powder coating for interior applications from Tiger; Austria). 0.2% AluOxid C were added. The batch was then mixed using the parameters 4 min.—stage 4. The dry-blend obtained was applied using a powder coating application device (GEMA EasySelect at 100 kV and 100 μA) to thin iron sheets and the sheets were then stoved for 10 min. at 180° C.

Test of Stability to Chemicals:

The above-described applications were subjected to an intensified chemicals test (in a slight modification of the test described in A. Albrecht, A.-U. Hirth and B. Schreiber, Farbe and Lack, 9/2008 pp. 52-56). Here, for 6 hours one drop each of 10% and 20% HCI and for 2, 4 and 6 hours one drop each of 5% and 10% NaOH were placed on the coated sheet. After the end of the test, the decomposition of the pigment was determined with reference to the graying compared with an unloaded sample. A grading from zero points for no visible decomposition up to 3 points for complete decomposition was carried out for each sample drop and then the total was found. In this test, a maximum of 24 points can be obtained as the poorest result.

TABLE 2
Corrosion resistances of powder coatings

| | Average | Total | |
|---|---|---|---|
| | particle size | of the | Corrosion |
| Metal-effect pigment | D50 (μm) | evaluation | resistance |
| Comparison example 7: | 20 | 5 | moderate |
| Eckart PCU 2000 | | | |
| (commercially available | | | |
| SiO2/polyacrylate-coated | | | |
| aluminum pigment) | | | |
| Example 1 according to | 35 | 4 | moderate |
| the invention | | | |
| Example 2 according to | 35 | 3 | good |
| the invention | | | |
| Example 3 according to | 35 | 2 | good |
| the invention | | | |
| Example 4 according to | 35 | 2 | good |
| the invention | | | |
| Example 5 according to | 35 | 2 | good |
| the invention | | | |
| Example 6 according to | 35 | 0 | very good |
| the invention | | | |
| Example 7 according to | 35 | 0 | very good |
| the invention | | | |
| Example 8 according to | 35 | 0 | |
| the invention | | | very good |
| Example 9 according to | 35 | 0 | |
| the invention | | | very good |

In particular the pigment applications of Examples 6 to 9 according to the invention show a very good corrosion resistance in this powder coating system for interior applications. This is even more startling in comparison with PCU 2000 as this pigment has a double protective coating made of SiO₂ and a polyacrylate. In particular the pigments of Examples 6 to 9 according to the invention showed an excellent compatibility with the powder coating system used, which in addition to very good optical properties should also contribute to high stability to chemicals.

Moreover, the application examples of the pigments of Examples 8 and 9 according to the invention had the best covering power and the strongest light-dark flop of all of the samples.

1. A metal-effect pigment comprising a metallic, plate-shaped core, which is coated with at least one polymer layer, wherein
the polymer layer comprises homogeneous and of the polyurea-type polymer, wherein the polyurea-type polymer of the polymer layer is obtained by an addition reaction of a component A with a component B,
wherein the component A comprises molecules comprising 1-20 primary and/or secondary amino groups and the component B comprises molecules comprising 1-20 isocyanate groups.

2. The metal-effect pigment according to claim 1,
wherein molecules of component A comprise 2 to 4 primary and/or secondary amino groups, and molecules of component B comprises 2 to 4 isocyanate groups.

3. The metal-effect pigment according to claim 1,
wherein the average layer thickness of the polymer layer is 5-1000 nm.

4. The metal-effect pigment according to claim 1,
wherein the polymer layer is 0.5-80 wt.-%, relative to the total weight of the coated metal pigment.

5. The metal-effect pigment according to claim 2,
wherein both component A and component B of the polyurea-type polymer layer further comprise one or more isophorone groups.

6. The metal-effect pigment according to claim 5,
wherein the component A is a mixture of an isophorone diamine and an aliphatic diamine, wherein the weight ratio of isophorone diamine to aliphatic diamine is 3:1 to 1:2.

7. The metal-effect pigment according to claim 1,
wherein the metallic plate-shaped core comprises at least one metal, and wherein the at least one metal is selected from the group consisting of aluminum, copper, tin, zinc, iron, chromium, nickel, silver gold, gold bronze, brass, steel, mixtures thereof and alloys thereof.

8. A method for the production of at least one metal-effect pigment according to claim 1, comprising:
coating the metallic plate-shaped core the presence of component A and component B.

9. A paint, printing ink, varnish, powder coating, plastic or cosmetic comprising the metal-effect pigment according to claim 1.

10. A coating system
comprising the metal-effect pigment according to claim 1.

11. The coating system according to claim 10, wherein
the coating system is selected from paints, printing inks, varnishes, powder coatings, plastics and/or cosmetics. .

12. A coated article, comprising
an article coated with the metal-effect pigment according to claim 1.

13. A coated article, comprising an coated article coated with the coating system according to claim 10.

14. The metal-effect pigment according to claim 1, wherein molecules of component A comprise 2 to 15 primary and/or secondary amino groups, and molecules of component B comprise 2 to 15 isocyanate groups.

15. The metal-effect pigment according to claim 1, wherein molecules of component A comprise 3 to 10 primary and/or secondary amino groups, and molecules of component B comprise 3 to 10 isocyanate groups.

16. The metal-effect pigment according to claim 1, wherein the polymer layer comprises 70 to 100 weight percent polyurea, relative to the total weight of the polymer layer.

17. The metal-effect pigment according to claim 1, wherein the polyurea-type polymer is treated with surface modifying agent(s) selected from amino silicone(s) and/or fatty amine(s).

18. The metal-effect pigment according to claim 1, wherein molecules of component A comprise less than 10 mole percent of hydroxyl groups.

19. The metal-effect pigment according to claim 1, wherein molecules of component A comprise one or more of isophorone diamine, 2,2,4-trimethylhexane diiamine, 2,4-toluylenediamine, ethylene diamine, propylene diamine, hexamethylene diamine or tetramethylene diamine, polyamidoamine, triethylene tetramine, N,N′-bis-(3-aminopropyl)ethylene diamine, N,N-dimethyldipropylene triamine, diethylene triamine and/or polyethylenimine.

20. The metal-effect pigment according to claim 1, wherein molecules of component A comprise one or more of isophorone diisocyanate, 2,2,4-trimethylhexane diisocyanate, 2,4-toluylene diisocyanate, hexamethylene diisocyanate or tetramethylene diisocyanate, and trimers thereof.

21. The metal-effect pigment according to claim 1, wherein the ratio of average diameter (D₅₀) to average thickness (h₅₀) is in a range of from 1000:1 to 5:1.
